(19) United States
(12) Patent Application Publication
(10) Pub. No.: US 2011/0010743 A1
(43) Pub. Date: Jan. 13, 2011

(54) Method for Re-establishment of Multimedia Content

(75) Inventors: Jean-Philippe Fournier, La Colle Sur Loup (FR); Charles Devaux, Puteaux (FR)

Correspondence Address: Blakely, Sokoloff, Taylor & Zafman, 1279 Oakmead Parkway, Sunnyvale, CA, 94085-4040, US

(73) Assignee: BOUYGUES TELECOM, BOULOGNE BILLANCOURT (FR)

(21) Appl. No.: 12/083,645

(22) PCT Filed: Oct. 13, 2006
(86) PCT No.: PCT/EP2006/067381

§ 371 Date: Sep. 14, 2010

(30) Foreign Application Priority Data
Oct. 14, 2005 (FR) 0510485

(51) Int. Cl. H04N 7/16

(52) U.S. Cl. 725/62

(57) ABSTRACT

The invention concerns a method for recording and reestablishing a multimedia content including the following steps: transmission of a multimedia content to a mobile terminal (107) is interrupted at a given time, a terminal (107, 108, 109) transmits to a server (110) a request for reestablishment of the content, the server (110) transmits in return to the terminal (107, 108, 109) the multimedia content based on the time of interruption of the transmission of the content.

The invention concerns the transmission of multimedia content to a mobile terminal.

Mobile telephone operators offer services for accessing multimedia contents, such as video-telephone, television or the downloading of video clips onto mobile telephones. These services require a transmission or broadcast in the form of a dataflow of multimedia content (audio or video).

These services allow a user for example to watch television in live on his mobile telephone.

However, a user, as he moves around, may be forced to interrupt the dataflow transmission.

This is the case for example when the user has only limited viewing time or when the user decides to interrupt the programme when he reaches his workplace or home.

The interruption of the broadcast of the content prevents the user from receiving the remainder of the content. The user does not therefore have the chance to access the whole of the multimedia content.

Furthermore, the user may also want to receive the remainder of the content on a terminal other than his mobile telephone.

This is the case for example when the user judges that the program he is viewing would deserve to be viewed on a larger screen than the screen of the mobile telephone.

One purpose of the invention is to allow a mobile user to access the whole of the multimedia content on a terminal of his choice.

This problem is resolved in the context of the present invention by using a method for recording and re-establishing a multimedia content comprising steps in which:

a transmission of a multimedia content to a mobile terminal is interrupted at a given time,

a terminal transmits to a server a request for re-establishment of the content,

the server transmits the multimedia content back to the terminal based on the time of interruption of the transmission of the content.

The method allows a user to receive the multimedia content he has missed on a terminal of his choice.

The method may have the following characteristics:
the method includes a step in which the server checks that a user of the terminal is entitled to a content re-establishment service,
the method includes a step in which the server retrieves the multimedia content corresponding to the content re-establishment request from a storage unit,
the method includes a step in which the server converts the recorded multimedia content into a multimedia content having a format adapted to the terminal, in order to transmit the converted multimedia content to the terminal,
the server transmits to the terminal a part of the multimedia content from a time of interruption of reception by the mobile telephone,
the method includes prior steps in which the terminal receives a multimedia content in the form of a dataflow, and the mobile terminal detects an interruption of a transmission of content,
the method includes a step in which, after detecting an interruption of a transmission of content, the mobile terminal sends a request to the server for the content to be recorded,
the method includes a step in which, when the server receives a multimedia content recording request sent by the mobile terminal, the server checks that a user of the terminal is entitled to a content re-establishment service,
the method includes a step in which, when the server receives a multimedia content recording request sent by the mobile terminal, the server selects a content source capable of providing the multimedia content in order to record the multimedia content with the best possible quality,
the method includes a step in which, when the server receives a multimedia content recording request sent by the mobile terminal, the server records the multimedia content from a content source in storage means,
the recording request includes data identifying the multimedia content and data identifying a time of interruption of the reception of the multimedia content.

The invention also relates to a multimedia content recording and re-establishment server, characterised in that it includes means for receiving a request for re-establishment of a content and means for transmitting the multimedia content back to a terminal based on a time of interruption of the content.

In one embodiment of the invention, the server includes storage means for recording a multimedia content from one or more content sources and means for converting the recorded multimedia content into a multimedia content having a format adapted to the terminal in order to transmit the converted multimedia content to the terminal.

Other characteristics and advantages will further emerge from the following description, which is purely illustrative and non-restrictive and must be read in relation to the appended figures among which:

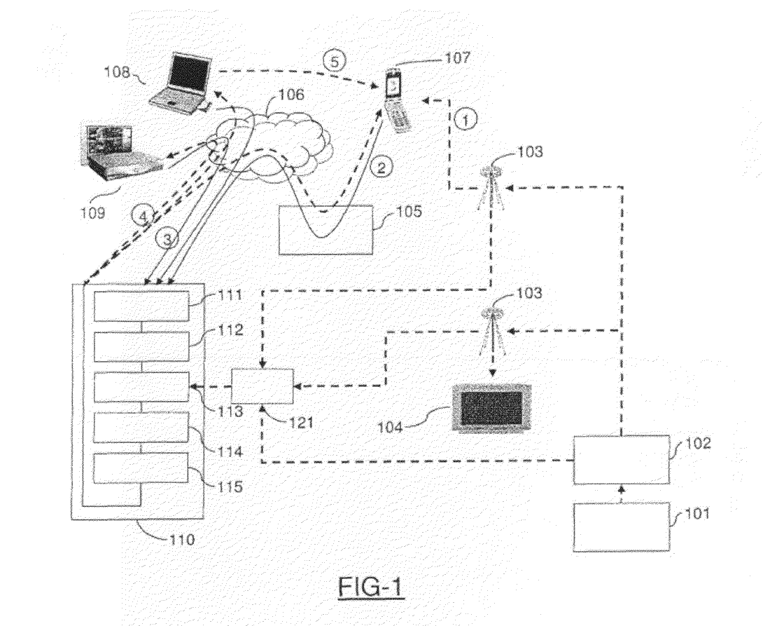

FIG. 1 shows diagrammatically different pieces of equipment that can be involved when implementing a method for recording and re-establishing a multimedia content, in accordance with the invention,

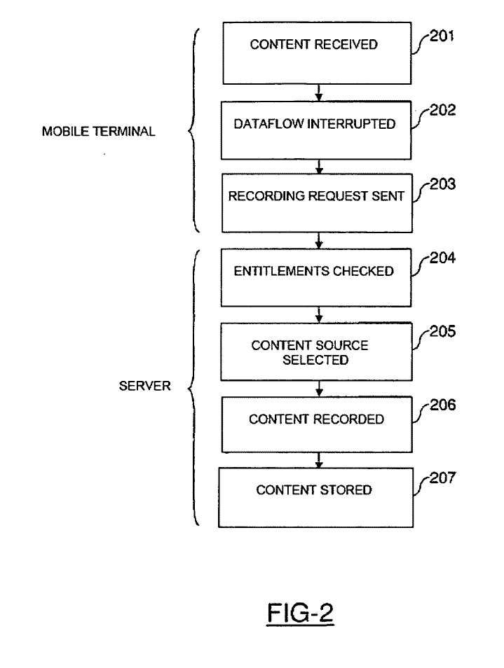

FIG. 2 shows diagrammatically steps in a method for recording a multimedia content, in accordance with a first embodiment of the invention,

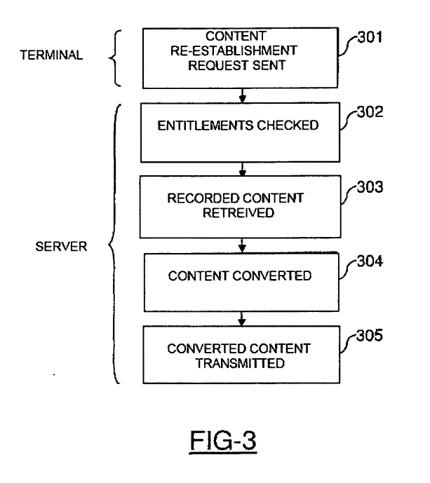

FIG. 3 shows diagrammatically steps in a method for re-establishing a multimedia content, in accordance with a first embodiment of the invention,

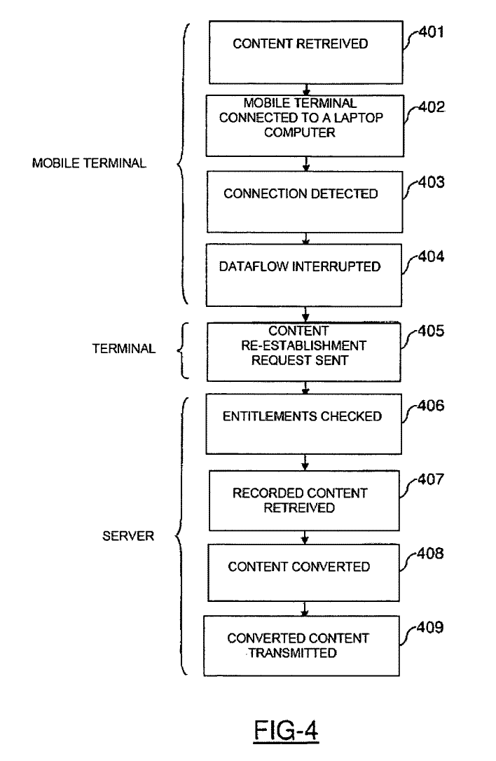

FIG. 4 shows diagrammatically steps in a method for re-establishing a multimedia content, in accordance with a second embodiment of the invention.

In FIG. 1, the equipment that may be involved when implementing a method includes a content provider 101, a broadcaster of digital content 102, a network of broadcasting antennae 103, a television set 104, a mobile telephone network 105, a communications network 106, a mobile terminal 107, a laptop computer 108, a television screen 109 fitted with a digital decoder (PVR or DVR or Set Top Box), a server 110 and a digital multi-decoder 121.

The content provider 101 is for example a television channel capable of generating audiovisual programmes.

The digital broadcaster 102 is capable of broadcasting contents generated by the provider 101 through the network of antennae 103. The content is broadcast in digital form, for example the contents are encoded according to the MPEG-2 standard.

The contents are broadcast in digital or analogical.

The mobile terminal 107, the laptop computer 108, the television screen 109 fitted with a decoder or a digital recorder and the television 104 are examples of visual display terminals intended to allow viewing of the contents broadcast by the digital broadcaster 102.

The mobile terminal 107 is for example a mobile telephone capable of receiving and decoding the digital content broadcast by the network of antennae 103. In the event of the content being streamed, the terminal 107 receives the contents in the form of a dataflow and the terminal is capable of reading and displaying the programmes on a screen in real time as the dataflow is received.

The communications network 106 is typically an Internet network.

The laptop computer 108 is capable of receiving multimedia contents through a domestic WiFi network connected to the communications network 106 via a high-speed ADSL link.

The television screen 109 is capable of receiving multimedia contents through a decoder or a digital recorder (PVR or DVR or Set Top Box).

The different terminals 107, 108 and 109 may comprise a storage space capable of storing multimedia contents.

The different terminals 107, 108 and 109 are capable of being connected to the server 110 through the mobile telephone network 105 and/or the communications network 106.

The server 110 includes a unit 111 for identifying and managing user entitlements, a programming unit 112, a recording unit 113, a storage unit 114 and a conversion unit 115.

The entitlements identification and management unit 111 includes a database storing user identification data and data on access entitlements for content broadcaster services.

The digital multi-decoder 121 is capable of receiving and decoding contents sent by a plurality of content sources, the content sources being able to be of different types. The digital multi-decoder 121 is for example capable of receiving the same content from a terrestrial broadcasting source or from a satellite broadcasting source.

FIG. 2 shows diagrammatically steps in a method for recording a multimedia content in accordance with a first embodiment of the invention.

According to a first step 201, the mobile terminal 107 receives a content in the form of a dataflow (1) sent by an antenna 103.

The dataflow (1) contains time markers identifying read times measured relative to a reference time (programme start time).

According to a second step 202, the mobile terminal 107 detects an interruption in the dataflow.

The mobile terminal 107 determines a time of interruption of the programme based on the last time marker received in the dataflow.

According to a third step 203, the mobile terminal 107 sends a content recording request (2) to the server 110.

For example, the request (2) is generated by the mobile terminal 107 in the form of a message (SMS). The message is transmitted to the server 110 through the mobile telephone network 105 and the communications network 105.

The message contains data identifying the user, data identifying the content (for example an identifier of the television channel broadcasting the content) and data identifying the time of interruption of the reception of the content.

According to a fourth step 204, the entitlements identification and management unit 111 processes the request message (2). The entitlements identification and management unit 111 identifies the user and checks that the user is entitled to benefit from the content recording and re-establishment service.

According to a fifth step 205, the programming unit 112 controls the recording unit so that the recording unit records the multimedia content.

To this end, the programming unit 112 selects a content source capable of providing the content so as to record the content with the best possible quality. In other words, the programming unit 112 selects the source providing the best content quality.

According to a sixth step 206, the recording unit 113 records the content sent by the selected source in the storage unit 114. The recording unit 113 receives the content broadcast by the digital broadcaster 2 through the digital multi-decoder 121.

According to a seventh step 207, the content is stored in the storage unit 114 in association with data identifying the user.

The content is thus stored for subsequent re-establishment.

FIG. 3 shows diagrammatically a method for re-establishing a multimedia content in accordance with a first embodiment of the invention.

It is assumed that the user wishes to recover the content recorded in the storage unit 114 during the recording process in FIG. 2.

It is assumed for example that the user wishes to receive the content on the laptop computer 108. (The same re-establishment method applies when the user wishes to receive the content on the mobile terminal 107 or on the television screen 109.)

According to a first step 301, the terminal 108 or 109 sends a content re-establishment request (3) to the server 110.

For example, the request is generated by the laptop computer 108 in the form of an http request through the communications network 106.

The re-establishment request (3) contains data identifying the user, data identifying the content (for example an identifier of the television channel broadcasting the content) and data identifying a re-establishment format.

The data identifying the re-establishment format include for example a screen size, a number of audio channels, a video flow rate supported by the terminal or a video compression type (codec).

According to a second step 302, the entitlements identification and management unit 1111 processes the request 3. The entitlements identification and management unit 111 identifies the user and checks that the user is entitled to benefit from the content recording and re-establishment service.

According to a third step 303, the programming unit 112 retrieves the content associated with the user from the storage unit 114.

According to a fourth step 304, the conversion unit 115 converts the recorded content into a content having a format adapted to be transmitted and read by the laptop computer 108.

According to a fifth step, the server 110 transmits the content (4) thus converted to the laptop computer 108 through the communications network 106.

The content (4) may be transmitted by streaming or be downloaded in the form of a file. It can be converted by the conversion unit 115 as it passes.

The user may thus read the content re-established by the server 110 on the terminal 108 or 109.

In the case of a content of significant size the user may choose to download the content (5) to the laptop computer 108 in a format adapted to the mobile telephone 107 and then transfer the downloaded content from the laptop computer 108 to the mobile telephone by means of a radio link (WiFi), a cable or a memory card (external storage device).

It will be noted that the server 110 is able to re-establish only a part of the content not yet viewed by the user. This is possible given that the terminal 107 transmits to the server 110 data identifying a time of interruption of the reception of the content.

FIG. 4 shows diagrammatically steps in a method for re-establishing a multimedia content, in accordance with a second embodiment of the invention.

In this second embodiment, the server 110 permanently records a plurality of contents broadcast by a plurality of content sources. The contents are recorded in the storage unit 114 of the server 110.

According to a first step 401, the mobile terminal 107 receives a content (1) in the form of a dataflow sent by an antenna 103.

The dataflow contains time markers identifying the read time measured relative to a reference time (programme start time).

According to a second step 402, the user connects the mobile terminal 107 to the laptop computer 108 or to the television screen 109.

According to a third step 403, the mobile terminal detects the connection to the laptop computer 108 or to the television screen 109. The mobile terminal 107 determines a connection time based on the last time marker received.

According to a fourth step 404, the mobile terminal 107 interrupts the dataflow which it receives from the antenna 103.

According to a fifth step 405, the laptop computer 108 or the television screen 109 sends a content re-establishment request (3) to the server 110.

The re-establishment request (3) contains data identifying the user, data identifying the content (for example an identifier of the television channel broadcasting the content) and data identifying a re-establishment format.

According to a sixth step 406, the entitlements identification and management unit 111 processes the re-establishment request (3). The entitlements identification and management unit 111 identifies the user and checks that the user is entitled to benefit from the content recording and re-establishment service.

According to a seventh step 407, the programming unit 112 retrieves the content from the storage unit 114.

According to an eighth step 408, the conversion unit 115 converts the content received by the recording unit 113 into a content having a format adapted so as to be transmitted and read by the laptop computer 108.

According to a ninth step 409, the server 110 transmits the content (4) thus converted to the laptop computer 108 through the communications network 106.

The content (4) can be transmitted by streaming or be downloaded in the form of a file. It may be converted by the conversion unit 115 as it passes.

The user is thus able to read the content re-established by the server 10 on the terminal 108.

It will be noted that the server 110 is able to re-establish only a part of the content not yet viewed by the user. This is possible given that the terminal 107 transmits data identifying a connection time to the server 110.

1. Method for recording and re-establishing a multimedia content including steps in which:
(202, 404) a transmission of a multimedia content to a mobile terminal is interrupted at a given time,
(301, 405) a terminal transmits a request for re-establishment of the content to a server,
(305, 409) the server transmits the multimedia content back to the terminal based on the time of interruption of the transmission of the content.

2. Method according to claim 1, including a step in which:
(302, 406) the server checks that a user of the terminal is entitled to a content re-establishment service.

3. Method according to claim 1, including a step in which:
(303, 407) the server retrieves the multimedia content corresponding to the content re-establishment request from a storage unit.

4. Method according to claim 1, including a step in which:
(304, 408) the server converts the recorded multimedia content into a multimedia content having a format adapted to the terminal, in order to transmit the converted multimedia content to the terminal.

5. Method according to claim 1, wherein the server transmits to the terminal a part of the multimedia content from a time of interruption of reception by the mobile terminal.

6. Method according to claim 1, including prior steps in which:
(201, 401) the terminal receives a multimedia content in the form of a dataflow,
(202, 404) the mobile terminal detects an interruption of a content transmission.

7. Method according to claim 6, including a step in which:
(203) after detecting an interruption of a content transmission, the mobile terminal sends a content recording request to the server.

8. Method according to claim 7, including a step in which:
(204) when the server receives a multimedia content recording request sent by the mobile terminal, the server checks that a user of the terminal is entitled to a content re-establishment service.

9. Method according to claim 7, including a step in which:
(205) when the server receives a multimedia content recording request sent by the mobile terminal, the server selects a content source capable of providing the multimedia content in order to record the multimedia content with the best possible quality.

10. Method according to claim 7, including a step in which:
(206) when the server receives a multimedia content recording request sent by the mobile terminal, the server records the multimedia content from a content source in storage means.

11. Method according to claim 7, wherein the recording request includes data identifying the multimedia content and data identifying a time of interruption of the reception of the multimedia content.

12. Server for recording and re-establishing a multimedia content, including means for receiving a content re-establishment request and means for transmitting the multimedia content back to a terminal based on a content interruption time.

13. Server according to claim 12, including storage means (114) for recording a multimedia content from one or more content sources and means (115) for converting the recorded multimedia content into a multimedia content having a format adapted to the terminal in order to transmit the converted multimedia content to the terminal.
